(19) United States
(12) Patent Application Publication
(10) Pub. No.: US 2026/0166557 A1
(43) Pub. Date: Jun. 18, 2026

(54) ROLLER MILL

(71) Applicant: Swisca AG, Appenzell (CH)

(72) Inventors: Theo Fäh, Appenzell (CH); Adrian Schaffer, Appenzell (CH)

(21) Appl. No.: 19/126,719

(22) PCT Filed: Nov. 6, 2023
(86) PCT No.: PCT/EP2023/080861

§ 371 Date: May 2, 2025

(30) Foreign Application Priority Data
Nov. 9, 2022 (CH) CH001333/2022

(51) Int. Cl. B02C 4/42; B02C 4/02

(52) U.S. Cl. CPC B02C 4/42; B02C 4/02

(57) ABSTRACT

A roller assembly includes first and second rollers, belt pulleys, tensioning pulleys, and a tensioning device. The first roller has a drive. The belt pulleys are coupled to each roller in a rotationally fixed manner. The tensioning pulleys are provided for each roller and are displaceable relative to the rollers. The tensioning device includes first and second tensioning elements. The first tensioning element is displaceable in the axial direction. The second tensioning element is coupled to the tensioning pulley mounting in a force-transmitting manner and is fixed with respect to the axial direction, (i.e., via a bearing journal). The second tensioning element is coupled to the first tensioning element via a spring element. The tensioning device permits the first tensioning element to be brought into a defined position relative to the second tensioning element by displacement in the axial direction, in particular by way of actuating an adjustment mechanism.

### BACKGROUND OF THE INVENTION

### Field of the Invention

The invention relates to a roller mill as well as to a roller assembly for a roller mill.

### Description of Related Art

Roller mills are used in cereal mills or other mills for the processing of foodstuff. A roller mill includes at least one pair-often two or four pairs-of grinding rollers, between which a grinding gap is formed on operation and which generally rotate at different speeds, in order to reduce the size of the grinding material in the grinding gap. Concerning this procedure, the grinding rollers are pressed against one another by way of high pressing forces.

In many roller mills, per roller pair one roller is driven whist the other roller is connected to the driven roller via an overdrive, and a desired rotation speed ratio is therefore enforced. Herein, the other roller in most cases rotates in an opposite sense of rotation, but with a different, mostly lower speed. Such an overdrive is generally formed by at least one belt. Since the rollers generally rotate in opposite directions, the belt must be arranged such that the belt pulley which is assigned to one of the rollers is arranged within the belt, and the belt pulley which is assigned to the other roller is arranged at the outside, wherein the belt moreover needs to revolve about a further co-rotating pulley, the so-called tensioning pulley. This also means that the belt needs to be structured at the inner side as well as the outer side such that it interacts with a pulley surface in a force-transmitting manner as efficiently as possible. The belt for example can include a poly-V profile at the inner side and be toothed at the outer side.

The tension of the belt is set by way of the position of the tensioning pulley. According to the state of the art, this is effected by way of the tensioning pulley being arranged on a lever whose position can be set by way of a setting screw or the like. In common roller mills, the quicker roller is driven and is arranged at the front, whereas the belt pulley which is assigned to this roller is arranged within the belt. Accordingly, the tensioning pulley which, too, is arranged within the belt lies behind the slower roller completely to the rear in the roller assembly, and the setting screw is consequently generally arranged on the roller assembly at the rear side. For this reason, it is hardly accessible when the roller assembly is installed into the roller mill, which is why a setting of the belt tension is quite tedious in the case of an installed roller assembly. Furthermore, the setting of the belt tension presupposes a measurement of the belt tension. This is effected in an indirect manner by way of tapping on the belt with a tool and measuring the frequency of the oscillation produced by this. This procedure, too, is relatively tedious and furthermore is to be carried out on poorly accessible elements, which leads to many users forgoing the measurement and carrying out the setting of the belt tension merely by instinct. This in turn results in roller mills often being in operation with poorly set belt tensions, which can lead to heavy wearing of the applied belts.

The publication U.S. Pat. No. 393,681 relates to a three-roller mill with an upper and a lower roller each with a smaller roller diameter and a middle roller with a larger roller diameter. The middle roller is driven, and the rotation of the middle roller is transmitted onto the other two rollers via an overdrive mechanism, the mechanism having one roll per roller and a belt which runs over the rolls. The rolls preferably have the same diameter, by which means the surface speeds of the middle roller on the one hand and of the upper and lower roller on the other hand are different on account of the different diameters of the rollers. The deflection roll is tensioned by way of an idler roll which is arranged on a lever element, wherein the lever element is tensioned by way of a spring which is arranged between the lever element and the head of a threaded rod whose axial position is displaceable by way of rotating a hand-wheel nut. The belt tension can therefore be influenced by way of rotating the hand-wheel nut. However, also this solution-like the aforedescribed state of the art-does not allow for the belt tension to be set in a reproducible manner independently of the state of the belt and without an additional measurement. The setting of the hand-wheel nut defines the position of the threaded rod and therefore its head. The tension of the spring however, apart from the position of the threaded rod, is also determined by the position of the lever element which for its part depends on the length—and herewith on the stretch—of the belt. For this reason, the position of the hand-wheel nut does not determine the spring tension in an unambiguous manner.

DE 12 13 709 relates to a roller mill with two rollers. The content of this publication is a mechanism with which the distance between the rollers can be set: if the rollers contact one another, the one roller drives the other—if not a roller overdrive with a chain is required. In order for the chain to be simply removable when the roller overdrive is not needed, a suitable mechanism is provided in order to pivot an idling pulley downwards, so that the chain is loose and can be simply removed. DE 12 13 709 has nothing to do with the setting of a belt tension.

CN 110421747 describes a machine for the size reduction of plastic for the purpose of recycling. The machine includes a belt which is tensioned by way of a gravity tensioning mechanism.

### SUMMARY OF THE INVENTION

It is the object of the present invention to provide a roller assembly for a roller mill as well as a roller mill with such a roller assembly, which at least in part overcome the disadvantages of the state of the art. In particular, the roller assembly shall be based on the common principle of driving—by a motor—only one of the two rollers, with a roller overdrive with a belt, wherein the roller overdrive defines the rotation speed of the other, for example slower roller relative to to the driven roller. Herein, it should permit a user-friendly setting of the belt tension and/or a good accessibility when setting the belt tension.

This object is achieved by the invention as defined in the patent claims.

According to an aspect of the present invention, the roller assembly includes a pair of rollers of which one, for example a first roller, includes a drive. A belt pulley each is assigned to both rollers and is coupled to the respective roller in a rotationally fixed manner (in theory, a coupling via a gear would also be conceivable). Moreover, the roller assembly includes a tensioning pulley whose mounting has a position which can be displaced relative to the rollers (at least to one of the rollers, i.e. in particular to that roller which is mounted in a stationary manner, mostly the first roller).

A belt of the roller assembly is arranged such that the first belt pulley is arranged within the belt and the second outside it, and the tensioning pulley, too, is arranged within the belt. Several belts which share the belt pulleys and the tensioning pulley or which are assigned to separate belt pulleys/tensioning pulleys can also be present. There is also a possibility of a further pulley being arranged within the belt, apart from the first belt pulley and the tensioning pulley, for example in order to achieve a particularly large wrap of the second belt pulley.

The roller assembly further includes a tensioning device which includes a first tensioning element and a second tensioning element. The first tensioning element is displaceable in an axial direction—for example relative to a stationary tensioning bearing. For example, the axial position of the first tensioning element can be displaceable relative to the tensioning bearing by way of an adjustment mechanism—for example by way of the first tensioning element being designed as a spindle which is displaceable by way of a rotation about its axis. The second tensioning element is coupled to the tensioning pulley mounting in a force-transmitting manner and in a manner which is fixed with respect to the axial direction, for example via a bearing journal. The second tensioning element is furthermore coupled to the first tensioning element via a spring element. The tensioning device is designed such that the user can bring the first tensioning element into a defined position relative to the second tensioning element by way of displacing in the axial direction, i.e. in particular by way of actuating the adjustment mechanism. In particular, the roller assembly is configured to bring the first tensioning element into a defined position relative to the second tensioning element, i.e. to permit the bringing of first tensioning element into a defined deposition relative to the second tensioning element. Accordingly, the roller assembly has the means to bring the first tensioning element into a defined, i.e. specified position relative to the second tensioning element, and this being independently of whether the belt (still) has a high elasticity or—for example if it has been in use for some time—less of an elasticity.

The distance by which the first tensioning element is displaced relative to the second (the “axial displacement”) is not identical to that by which the first tensioning element is displaced relative to a stationary bearing, the tensioning bearing, because due to the elasticity of the belt, on applying a force, also the tensioning pulley, the tensioning pulley bearing and herewith also the second tensioning element are moved.

By way of the position of the first tensioning element to the second tensioning element, i.e. the position of the two elements which are coupled via a spring element, being settable as in accordance with the procedure described here, also the relative force is also defined—via the characteristics of the spring element, thus in particular via Hook's law. By way of the spring force acting, on the one hand, between the first tensioning element and, accordingly, the tensioning bearing (whose axial position can be fixed with the housing or can, at all events, be in a defined position relative to the first roller) and, on the other hand, the second tensioning element and, accordingly, the tensioning pulley mounting, the spring force is proportional to the force with which the tensioning pulley is pressed against the belt and, accordingly, to the tension of the belt. The procedure according to the invention therefore permits a setting of the belt tension which is difficult to determine and to define, by way of setting a relative position which is simple to determine and to define.

In other words, the tensioning device in particular is configured to set a predefined belt tension without having to measure the belt tension.

For setting the defined position of the first tensioning element relative to the second tensioning element, the roller assembly is configured to allow this defined position—in which the belt is tensioned by the tensioning pulley (with the desired, appropriate tensioning force)—to be examined.

The fact that the roller assembly is configured to examine the defined position means that such an examination would not only be theoretically possible, but that the roller assembly itself includes the means which are necessary therefor. I.e. the roller assembly in particular includes the means for an operating person to examine this position, for example in a tool-free manner, i.e. without further aids being required. Such means of the roller assembly for example can include at least one marking on the first tensioning element and/or on the second tensioning element, a detent structure or a stop, a dimensioning such that structures are aligned to one another on reaching a predefined axial displacement, or a measuring device for measuring the position, for example a longitudinal scale, an electronic measuring device—optionally including an automation which sets a predefinable axial displacement and thus sets a belt tension, etc. There is also a possibility of the roller assembly being configured such that although a separate tool is necessary depending on the desired belt tension, this tool however is a simple one and can be simply applied, for example a scale or a slide caliper for measuring a depth or a protrusion.

In embodiments, the tensioning pulley mounting is arranged and mounted on a movable carrier element, in particular on a pivotable lever, on which the second tensioning element engages.

In particular, the first tensioning element can be a spindle, i.e. an element which together with another element which in particular is stationary with respect to axial directions (“stationary” here means: fixed with respect to a mechanical carrier structure of the roller assembly) converts a rotation movement into a translatory movement along the axis. Herein, there is not only the possibility of a spindle bearing, as the stationary tensioning bearing, being fixedly assembled and the spindle being rotatable, but also the possibility of attaching the spindle bearing in a rotatable (but axially non-displaceable, thus stationary) manner and of designing the spindle movable only in the axial direction. The spindle can furthermore be provided with a lock nut by way of which a position can be fixed once it is set.

The spring device can be a helical spring, a spring assembly (assembly of plate springs or the like) or any device with reproducibly resilient characteristics. In particular, the spring device can be configured and arranged such that on applying the belt tension, it is loaded in compression, i.e. the spring device is compressed between the first tensioning element and the second tensioning element.

In embodiments, the second tensioning element has a component which extends through the spring device and/or along the spring device in the axial direction up to the first tensioning element, and, for example, also reaches through the first tensioning element and/or along it. By way of this, the axial displacement can be defined in a simple manner by way of a marking, a stop, a detent structure, structures which are to be aligned to one another, etc. Such a component for example can be a push rod.

As is known per se, generally one of the rollers is mounted in a stationary manner whilst the other roller can be moved out, i.e. the bearing body which mounts it can be moved away from the bearing body of the stationarily mounted roller by a certain distance, so that the rollers do not press on one another when no product is between them. The stationarily mounted roller as a rule is the driven roller (for example the first roller) and in particular it can be arranged in the roller mill at the front, thus at the side from which the operating person has access to the components of the roller mill.

In embodiments, the tensioning device is installed such that it is accessible from and can be operated from the front side of the roller mill. In particular, the tensioning device includes an operating structure via which the operating person can tension the belt and set the belt tension. The operating structure comprises, for example, a structure for a turning tool (for example a “screw head structure”: a hexagonal structure, a head with hexagon socket, or another structure for a turning tool), or a structure for manual operation (rotary wheel etc.).

This operating structure is arranged on the tensioning device such that it is accessible from the front, for example by way of a hinged lid or a door or a removable wall piece of the roller mill. Specifically, the tensioning device can be coupled at the rear side to a movable carrier element, in particular a pivotable lever, with the tensioning pulley mounting. Herein, the tensioning pulley can be arranged behind the second belt pulley when it is assigned to the indirectly driven roller which can be moved out, i.e. the indirectly driven roller, with regard to horizontal directions perpendicularly to the roller axis, is arranged between the tensioning pulley and the first, directly driven roller. The tensioning device then extends from the rear side past the second belt pulley, and the operating structure is arranged on the tensioning device at the front side. A tensioning of the tensioning device (for example a tightening of the spindle) therefore presses the carrier element to the rear.

A roller mill with a plurality of roller pairs can in particular include two roller assemblies which are arranged back to back, i.e. the second rollers of the two roller assemblies which can be moved out are arranged next to one another, wherein the first rollers as well as the operating structures of the tensioning devices of the two roller assemblies each belong to a front side of the roller mill (generally the roller mill is arranged such that it is accessible from both sides, so that both sides each form a front side of the roller mill, as viewed by the operating person).

In a group of embodiments, the tensioning device is fastened (in particular in a pivotable manner) at an end to the carrier element, for example to a lever, to which the tensioning pulley is mounted. In this group of embodiments, the tensioning device is mounted at another point such that it is pivotable about at least one and in particular about two axes which are different from the main axis (which defines the axial direction). I.e. the axis along which the first tensioning element is displaceable is, as a whole, pivotable and specifically pivotable about a first pivot axis and, for example, also about a second pivot axis, wherein the first pivot axis and the second pivot axis are different from the main axis and, for example, are perpendicular thereto, and wherein the first pivot axis and the second pivot axis are different from one another and, for example, are perpendicular to one another. In the case of pivotability about a first pivot axis and second pivot axis, the tensioning device is thus mounted in a cardanic manner.

It has been found that such a mounting with pivotability about a first axis and also about a second axis can be advantageous. In particular, it has been found that transverse forces can result from tensioning the belt as well as from moving the rollers in and out and also, possibly, from operation because of different thermal expansions etc, wherein these transverse forces can be efficiently accommodated by the cardanic mounting, which is why the belt is also not-indirectly-loaded by such transverse forces. In other words, it has been found that the service life of the used components can be improved in a simple and efficient manner by way of the cardanic mounting.

A further advantage is the fact that the “cardanic” suspension can prevent possible undesired transverse forces also when the second roller is moved out relative to the first roller by a comparatively large distance where the roller assembly is configured to maintain a minimal tension on the belt even given a moving-out by this comparatively large distance, so that the belt cannot completely release. In this manner, the suspension interacts particularly well with the design according to the invention with the spring element between the first and the second tensioning element: the spring element makes possible that the minimal tension on the belt is maintained by way of it compensating a change of the axial distance between the tensioning pulley on the one hand and the stationary tensioning bearing of the first tensioning element (for example spindle bearing) on the other hand.

A pivotability about a first and a second pivot axis can be effected, for example, by way of a bearing element relative to which the tensioning device is pivotable up to a certain degree, being mounted in a rotatable manner.

According to an embodiment, such a bearing element engages with a tensioning device housing at the outside, the housing for example surrounding the spring element. For this purpose, the tensioning device housing can include bearing projections at the outer side, a receiver of the tensioning device housing gripping in a fork-like manner around the bearing projections—or vice versa.

In particular, one can envisage the first and the second pivot axis being arranged on the tensioning device not at the end side, but at a distance to both ends of the tensioning device, for example roughly in its centre of gravity.

Apart from the roller assembly, a roller mill also belongs to the subject-matter of the present invention. The roller mill includes at least one roller assembly of the type which is described here. The roller assembly can be present as a module in the sense that the roller assembly can be disassembled from the roller mill as a whole, for example for maintenance purposes or if it is to be exchanged. The term “roller assembly” however does not necessarily mean that this needs to be the case: a roller assembly in the context of the present text is also present if two rollers as well as the further elements which are defined here (belt pulleys, tensioning pulley, tensioning device) are present and interact, even if the rollers are mounted for example on a roller mill carrier structure and need to be disassembled individually, after removal of the belt.

The roller mill, in a manner known per se, can also include, apart from the roller assembly, a feed device for feeding grinding material into the grinding gap between the rollers. The roller mill can include several roller pairs, to which for example at least two roller assemblies of the type described here belong. As described above, these can be arranged back to back, so that both tensioning devices are easily assessable from one side.

Furthermore, a method for setting the belt tension of a roller assembly of the type which is defined and described in this text belongs to the invention. The method firstly includes the step of setting a position of the first tensioning element relative to the second tensioning element, said position defining and determining the belt tension, and secondly the subsequent step of bringing the first tensioning element into the position relative to the second tensioning element defined by the first step.

### BRIEF DESCRIPTION OF THE DRAWINGS

Embodiment examples of the invention are hereinafter described by way of drawings. In the drawings, the same reference numerals denote equal or analogous elements. The drawings in part are schematic and not true to scale. They show elements which partly correspond to one another in sizes which differ from figure to figure. There are shown in:

FIG. 1: a side view of elements of a roller assembly with two rollers;

FIG. 2: shows a side view of the elements according to FIG. 1, sectioned along the plane II-II in FIG. 3;

FIG. 3: a bottom view of the elements according to claim 1, wherein only such a region of the roller assembly is shown which faces to the side with the roller overdrive; and

FIG. 4 a very schematic representation of a roller mill.

### DETAILED DESCRIPTION OF THE INVENTION

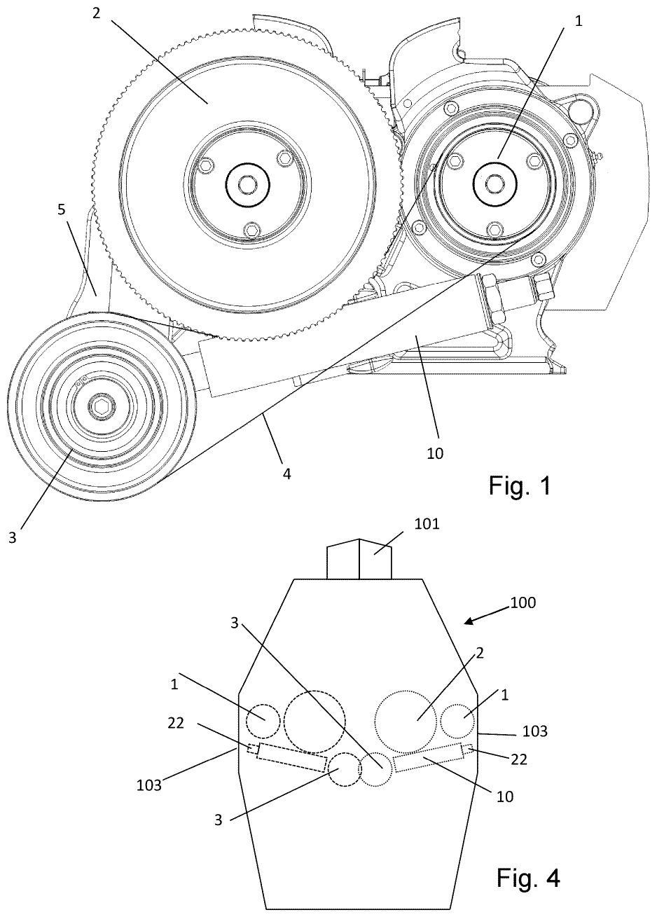

FIG. 1 shows a side view of elements of a roller assembly with two rollers which are each mounted by a bearing body, of which one bearing body is fixed and the other is movable, so that one roller can be moved out relative to the other. For the purpose of a better overview, elements of a corresponding moving-out mechanism are not represented in FIG. 1. The roller assembly is present for example as a module of the roller mill or can be installed into such. The roller assembly includes a first, quicker roller and a second, slower roller. The axes of the quicker and the slower roller run perpendicularly to the plane of the drawing. Herein, the quicker roller is arranged on the roller mill at the front, i.e. at the side to which the operating person has access, for example by way of opening a hinged lid or the like. The rear side, i.e. the side of the slower roller (at the left in the figures) in contrast is not easily accessible, for example because the roller mill includes a further roller pair on the plane of the represented roller pair, behind the represented roller pair. The rear, slower roller is generally the roller which is mounted by the movable bearing body, i.e. the driven roller is fixedly assembled (with respect to the mechanical carrier structure 41).

The quicker roller is connected to a drive at an end of the rollers, specifically at the end which is not represented in FIG. 1, i.e. the quicker roller is actively driven. At the opposite end, represented in FIG. 1, a first belt pulley 1 is assigned to the quicker roller and is connected to the roller in a rotationally fixed manner. The slower roller is connected to the second belt pulley 2 in a rotationally fixed manner. The second belt pulley 2 has a larger diameter than the first belt pulley 1. A tensioning pulley 3 is also represented.

The first belt pulley 1 and the second belt pulley 2 are connected via a belt 4, wherein the first belt pulley 1 as well as the tensioning pulley 3 are arranged within the belt 4, and the second belt pulley 2 is arranged outside the belt 4, so that the first belt pulley 1 and the second belt pulley 2 rotate in opposite directions due to the coupling via the belt 4, but at different speeds due to the different diameters, resulting in the desired grinding effect. In the example shown, the belt 4 at the outer side is provided with a toothing, and the second belt pulley 2 includes a corresponding toothing. At the inner side, the belt can have a different structure, for example a poly-V profile, wherein the first belt pulley 1 is structured accordingly.

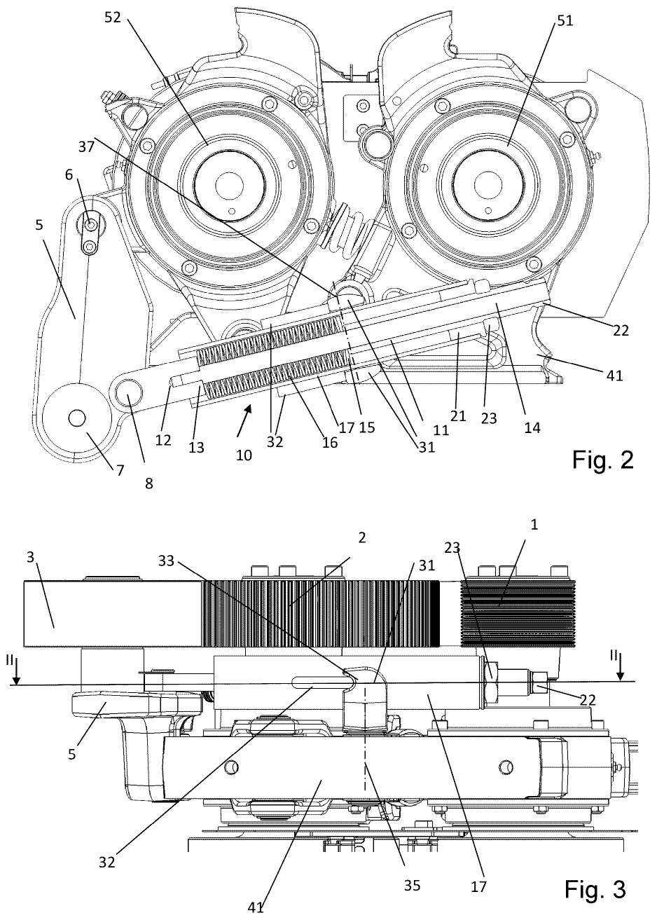

A tensioning device 10 ensures that the tensioning pulley 3 is pressed outwards (to the left in FIG. 1) with a desired force, in order to maintain the belt 4 in a constantly tensioned manner during the operation. The tensioning pulley 3 is arranged on a lever 5 which is pivotable about an axis which is defined by a rotation journal 6 which is shown in FIG. 2.

FIG. 2 shows a side view of the elements according to FIG. 1, sectioned along a plane which lies behind the first and the second belt pulley and which goes through the tensioning device 10 (plane II-II in FIG. 3). Apart from the bearings 51, 52 for the quicker and slower roller respectively, one can see in particular the construction of the tensioning device 10. This includes a first tensioning element with a spindle and an (optional) spindle disc 15 which is connected to a push ensemble 12 as a second tensioning element via a spring assembly 16. The push ensemble 12 includes a push piston 13 and a push rod 14. The push piston 13 is connected to the lever 5 and is pivotably fastened thereto (bearing journal 8), so that a push force at the push piston 13 presses the lever 5 to the rear, i.e. to the left in the figures.

The push rod 14 is fixedly connected to the push piston 13 and extends therefrom through the spring assembly 16 and the spindle 11 to the front in the axial direction (“axial” with respect to the spindle 11).

For tensioning the belt, the spindle 11 is tightened by way of it being rotated about its axis, for example via a hexagonal socket 22 or another structure which permits an engagement of a tool, or also via a rotary wheel or the like. For this purpose, a spindle bearing 21 which is fixedly connected to the tensioning device housing 17 includes an inner thread which is matched to the spindle 11. The tightening of the spindle presses the spindle disc 15 to the rear and thus tensions the spring assembly 16, by which means the lever 5 with the tensioning pulley 3 is, too, pressed to the rear by the push piston 13 and tensions the belt 4. If the belt is adequately tensioned, the spindle 11 can be fixed by a lock nut 23. The belt tension is a function of the force with which the tensioning pulley is pressed to the rear, and this in turn, with the exception of a possible proportionality factor (position of the tensioning pulley mounting 7 of the tensioning pulley 3 relative to the position of the bearing journal 8), corresponds to the push force upon the push piston 13.

The push force upon the push piston 13 is directly dependent on the axial displacement of the spindle 11 relative to the push ensemble 12 with the push piston 13 and the push rod 14, via Hook's law. This displacement in turn, apart from the displacement of the spindle 11 relative to the spindle bearing 21, also depends on the characteristics of the belt 4, specifically on its elasticity. This means that when the spindle 11 is advanced axially relative to the spindle bearing 21 by a specified path distance (corresponding to a defined number of revolutions or a defined revolution angle), it is displaced relative to the push ensemble by another, generally shorter path distance, specifically the path distance which in this text is called “axial displacement”. It is only this axial displacement which is proportional to the spring tension and thus to the belt tension.

On account of the push ensemble also including the push rod 14 apart from the push piston 13, the user can examine the axial displacement, for example by way of a marking on the push rod 14 or on the spindle, by way of measuring the screw-in depth of the spindle 11 relative to the push rod 14, by way of reaching a corresponding stop, by way of the user bringing the spindle 11 into a predefined position relative to the push rod 14 (for example flush with the push rod 11 as is illustrated), etc. In this manner, the procedure according to the invention permits the direct setting of the belt tension by an operating person in a manner which is simple for him/her, without him/her having to measure the belt tension or knowing the elasticity of the belt.

The elements of the tensioning device 10 relative to which the spindle 11 is pressed to the rear when it is tightened, are assembled on the mechanical carrier structure 41 such that they can accommodate axial forces. However, they are mounted such that no transverse forces are transmitted onto the lever 5. A jamming of the tensioning device is avoided since it can align itself in the joint. A jamming could lead to friction at the spring elements and herewith could reduce the belt tension in a manner which is difficult to control. For this propose, the roller assembly includes a bearing element 31 which is rotatably mounted about a horizontal axis 35 (first pivot axis) represented in FIG. 3, and which grips around the tensioning device housing 17 from the one side in a fork-like manner. At the upper side and at the lower side of the tensioning device housing 17, the bearing element 31 forms a receiver 33 for a bearing projection 32 on the tensioning device housing 17. The interaction of the bearing projection 32 with the bearing element 31 represents a stop for the tensioning device housing 17 for movements in the axial direction and permits the bearing element 31 to accommodate, via the spindle bearing 21, the tensioning device housing 17 and the bearing projections 31, the axial forces which are applied to the spindle 11 upon tensioning the belt. Herein, the tensioning device housing 17 is also guided on account of the concave shape of the receivers 33. However, pivoting movements perpendicular to the axis are permitted in both directions, namely vertically (due to the rotatability about the horizontal axis 35/first pivot axis) and horizontally (due to the open shape of the receivers 33) about the second pivot axis 37 which is perpendicular to the axial direction and to the first pivot axis.

The tensioning device 1 is installed such that it is accessible from the front, i.e. from the right in the illustrated orientation, i.e. the operating structure (here: hexagonal socket 22) is arranged in front of the tensioning pulley and also in front of the second belt pulley 2. This is made possible by way of the design and arrangement of the tensioning device 10. Firstly, it is namely provided that the push ensemble 12 engages on the lever 5, specifically on the same side with respect to its lever pivot axis as where the tensioning pulley 5 is arranged. Secondly, the tensioning device has the construction as described above according to which the push ensemble 12 is subjected to the force which is necessary for tensioning the belt via a spring assembly 16, wherein the latter again is tensioned via the spindle 11—and for this reason the spindle 11, with respect to axial directions, is arranged on the other side of the spring assembly than is the push piston 13 upon which the spring assembly 16 acts—i.e. in front of the spring assembly 16. The advantageous accessibility of the operating structure from the front therefore results in a simple manner.

A roller mill 100 with two roller pairs and with a grinding product inlet 101 is seen in FIG. 4. Roller assemblies of the type which are described in this text are present in the inside of the roller mill housing. The roller assemblies are arranged below a feed device which is not represented in FIG. 4. FIG. 4 schematically shows front views the belt pulleys 1, 2 as well as the tension pulleys 3 and the tensioning devices 10 of the two roller assemblies being represented by dashed lines. Since the roller assemblies are, for example, identically constructed, the arrangement of the belt pulleys, tensioning pulleys and tensioning devices can be point reflected. This also means that these elements are arranged on different planes—seen from a certain side:
to the left and right of the four grinding rollers—as is indicated in FIG. 4 by different illustrations of the two componentries. The operating structures 22 of the tensioning devices 10 are, for each roller assembly, present at the front side, i.e. they are accessible through a door, a hinged lid or a simply removable front wall panel 103, in order to examine the belt tension and/or readjust this when necessary.

1. A roller assembly for a roller mill, comprising a first roller and a second roller, wherein a first belt pulley is assigned to the first roller and a second belt pulley is assigned to the second roller, wherein the roller assembly comprises a belt and a tensioning pulley, wherein the first belt pulley and the tensioning pulley are arranged within the belt, and the second belt pulley is arranged outside the belt, wherein the tensioning pulley is mounted by a tensioning pulley mounting which has a movable position, and wherein the roller assembly comprises a tensioning device with which the tensioning pulley mounting can be subjected to a force in order to tension the belt, wherein the tensioning device comprises a first tensioning element and a second tensioning element, wherein the first tensioning element is displaceable relative to the second tensioning element in an axial direction counter to a spring force of a spring element, that the second tensioning element is coupled to the tensioning pulley mounting, and that the first tensioning element can be brought into a defined position relative to the second tensioning element by way of displacing in the axial direction.

2. The roller assembly according to claim 1, comprising a stationary tensioning bearing, relative to which the first tensioning element is axially displaceable.

3. The roller assembly according to claim 2, wherein the first tensioning element is a spindle, and the tensioning bearing is a spindle bearing, comprises an inner thread and receives the spindle, whereby the first tensioning element is displaceable in the axial direction by way of a relative rotation between the spindle and the tensioning bearing.

4. The roller assembly according to claim 1, which is configured to allow the position of the first tensioning element relative to the second tensioning element to be examined.

5. The roller assembly according to claim 4, wherein the first tensioning element and/or the second tensioning element comprises at least one marking for examining the position of the first tensioning element relative to the second tensioning element, and/or the first and the second tensioning element are dimensioned such that they are aligned to one another on reaching a defined relative position.

6. The roller assembly according to claim 1, wherein the second tensioning element extends through the spring element and/or along the spring element, up to the first tensioning element.

7. The roller assembly according to claim 6, wherein the second tensioning element extends through the first tensioning element and/or along the first tensioning element.

8. The roller assembly according to claim 1, wherein the first roller is mounted in a stationary manner and the second roller can be moved out relative to the first roller, wherein the first roller is arranged towards a front side of the roller assembly, and the second roller is arranged towards a rear side of the roller assembly, wherein the tensioning device is installed such that the coupling to the tensioning pulley mounting is arranged at a rear side of the tensioning device, and an operating structure is arranged at a front side of the tensioning device.

9. The roller assembly according to one claim 1, wherein an end of the tensioning device is fastened to a movable carrier element, on which the tensioning pulley mounting is mounted, and wherein the tensioning device is, at a location different from said end, pivotably mounted about a first pivot axis and about a second pivot axis.

10. The roller assembly according to claim 9, wherein the axial direction defines a main axis, and wherein the first pivot axis and the second pivot axis are orthogonal to the main axis and to one another.

11. The roller assembly according to claim 9, comprising a bearing element which is rotatably mounted relative to a carrier structure of the roller assembly about the first pivot axis and which mounts the tensioning device such that it is pivotable relative to the bearing element about the second pivot axis.

12. The roller assembly according to claim 1, wherein an end of the tensioning device is fastened to a movable carrier element, wherein the movable carrier element is a pivotable lever, wherein the fastening of the tensioning device and the tensioning pulley mounting are arranged on a same side of the lever with respect to a rotary point of the lever.

13. A roller mill comprising at least one first roller assembly according to claim 1, and a feed device for feeding a grinding material to the rollers of the first roller assembly.

14. The roller mill according to claim 13, wherein a front side, from which the roller assembly is accessible, is defined, wherein a rear-side end of the tensioning device is coupled to the tensioning pulley mounting, and wherein an operating structure by way of which the axial displacement of the first tensioning element relative to the second tensioning element can be effected is present on the tensioning device at the front side.

15. The roller mill according to claim 13, comprising at least one additional second roller assembly, wherein the second roller of the first roller assembly and the second roller of the second roller assembly are arranged next to one another.
